(19) United States
(12) Patent Application Publication
(10) Pub. No.: US 2014/0198064 A1
(43) Pub. Date: Jul. 17, 2014

(54) TOUCH SENSITIVITY CONTROL METHOD AND ELECTRONIC DEVICE THEREFOR

(71) Applicant: Samsung Electronics Co., Ltd., Suwon-si (KR)

(72) Inventors: Dae-Kwang KIM, Hwaseong-si (KR); Hyun-Ju HONG, Hwaseong-si (KR); Hee-Sung KIM, Suwon-si (KR)

(73) Assignee: Samsung Electronics Co., Ltd., Suwon-si (KR)

(21) Appl. No.: 14/079,246

(22) Filed: Nov. 13, 2013

(30) Foreign Application Priority Data
Jan. 11, 2013 (KR) 10-2013-0003396

(51) Int. Cl. G06F 3/041

(52) U.S. Cl. CPC G06F 3/0416
USPC 345/173

(57) ABSTRACT

An apparatus and a method for controlling touch sensitivity according to hydroplaning of a touch screen in an electronic device are provided. The method includes estimating whether a water film is generated on a surface of a touch screen in consideration of at least one of position information, humidity, and a temperature change of the electronic device and adjusting touch detection sensitivity of the touch screen when it is estimated that the water film is generated on the surface of the touch screen.

### CROSS-REFERENCE TO RELATED APPLICATION(S)

This application claims the benefit under 35 U.S.C. §119(a) of a Korean patent application filed on Jan. 11, 2013 in the Korean Intellectual Property Office and assigned Serial No. 10-2013-0003396, the entire disclosure of which is hereby incorporated by reference.

### TECHNICAL FIELD

The present disclosure relates to an electronic device. More particularly, the present disclosure relates to an apparatus and a method for controlling touch sensitivity in an electronic device.

### BACKGROUND

As the use of multimedia services by electronic device has increased, an amount of information processed and displayed in the electronic devices has also increased. Accordingly, there is a growing interest in electronic devices including a touch screen, which may improve space utilization and increase a size of a display unit thereof.

The touch screen is an input and display device for inputting and displaying information on one screen. Accordingly, when the touch screen is installed in the electronic device, the electronic device may increase a display size by removing a separate input device, such as a keypad. For example, a touch screen with a full touch type in which the entire screen is applied to the touch screen is installed in the electronic device, the electronic device may enlarge a screen size by using the entire surface as a screen.

Touch input types of the electronic device having the touch screen may include a resistive touch type and a capacitive touch type.

When the capacitive touch type is used, the electronic device determines a touch coordinate in consideration of a capacitance change generated when a user touches a touch screen with his or her fingers, and the like.

As described above, when the capacitive touch type is used, because the electronic device operates by a capacitance change, there is a problem in that a touch recognition error is generated on the touch screen by humidity, and the like. In one example, when the electronic device using the capacitive touch type is moved from a cool place to a warm place, because an error is generated in a capacitance change by touch input generated by the user and a water film generated on a surface of the touch screen, there is a problem in that the electronic device does not perform accurate touch recognition. In another example, when the user uses the electronic device using the capacitive touch type externally on a rainy day, because an error is generated in a capacitance change by touch input generated by the user and a water film generated on a surface of the touch screen, there may be a problem in that the electronic device may not perform accurate touch recognition.

Therefore, a need exists for an apparatus and a method for controlling touch sensitivity in an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for controlling touch sensitivity in an electronic device.

Another aspect of the present disclosure is to provide an apparatus and a method for controlling touch sensitivity according to position information in an electronic device.

Another aspect of the present disclosure is to provide an apparatus and a method for controlling touch sensitivity in consideration of humidity in an electronic device.

Another aspect of the present disclosure is to provide an apparatus and a method for controlling touch sensitivity in consideration of temperature which is sharply changed to a high temperature in the electronic device.

In accordance with an aspect of the present disclosure, a method for controlling touch sensitivity in an electronic device is provided. The method includes estimating whether a water film is generated on a surface of a touch screen in consideration of at least one of position information, humidity, and a temperature change of the electronic device and adjusting touch detection sensitivity of the touch screen when it is estimated that the water film is generated on the surface of the touch screen.

In accordance with another aspect of the present disclosure, an electronic device is provided. The electronic device includes a touch screen, at least one processor, at least one memory, and at least one program which is stored in at least the one memory and is configured to be executable by at least the one processor, wherein at least the one processor estimates whether a water film is generated on a surface of a touch screen in consideration of at least one of position information, humidity, and a temperature change of the electronic device and adjusts touch detection sensitivity of the touch screen when it is estimated that the water film is generated on the surface of the touch screen.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a block diagram illustrating a configuration of a processor according to an embodiment of the present disclosure;

FIG. 3A is a flowchart illustrating a process of estimating whether a water film is generated on a surface of a touch screen and adjusting touch detection sensitivity of the touch screen according to an embodiment of the present disclosure;

FIG. 3B is a block diagram illustrating a configuration of an electronic device for estimating whether a water film is generated on a surface of a touch screen and adjusting touch detection sensitivity of the touch screen according to an embodiment of the present disclosure;

FIG. 4 is a flowchart illustrating a process of setting a water film mode in consideration of position information in an electronic device according to an embodiment of the present disclosure;

FIG. 5 is a flowchart illustrating a process of setting a water film mode in consideration of humidity in an electronic device according to an embodiment of the present disclosure;

FIG. 6 is a flowchart illustrating a process of setting a water film mode in consideration of temperature which is sharply changed to a high temperature in an electronic device according to an embodiment of the present disclosure;

FIG. 7 is a flowchart illustrating a process of setting a water film mode in consideration of a temperature change and humidity in an electronic device according to an embodiment of the present disclosure;

FIG. 8 is a flowchart illustrating a process of setting a water film mode in consideration of position information and humidity in an electronic device according to an embodiment of the present disclosure;

FIG. 9 is a flowchart illustrating a process of setting a water film mode in consideration of position information and a temperature change in an electronic device according to an embodiment of the present disclosure;

FIG. 10 is a flowchart illustrating a process of setting a water film mode in consideration of position information, a temperature, and humidity in an electronic device according to an embodiment of the present disclosure; and

FIG. 11 is a screen illustrating a process of setting a water film mode in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, a description will be given for an apparatus and a method for controlling touch sensitivity in an electronic device and also, for controlling touch sensitivity according to hydroplaning of a touch screen in an electronic device.

Hereinafter, the term water film mode denotes a mode for reducing touch detection sensitivity of a touch screen to detect strong capacitance through a touch screen and not to detect weak capacitance, when it is estimated that a water film is generated on a surface of the touch screen.

Hereinafter, the term electronic device refers to any one of a mobile communication terminal, a Personal Digital Assistant (PDA), a laptop, a smart phone, a netbook, a television, a Mobile Internet Device (MID), a Ultra Mobile Personal Computer (UMPC), a tablet PC, a navigation device, a Moving Picture Experts Group (MPEG) layer 3 (MP3) player, and the like.

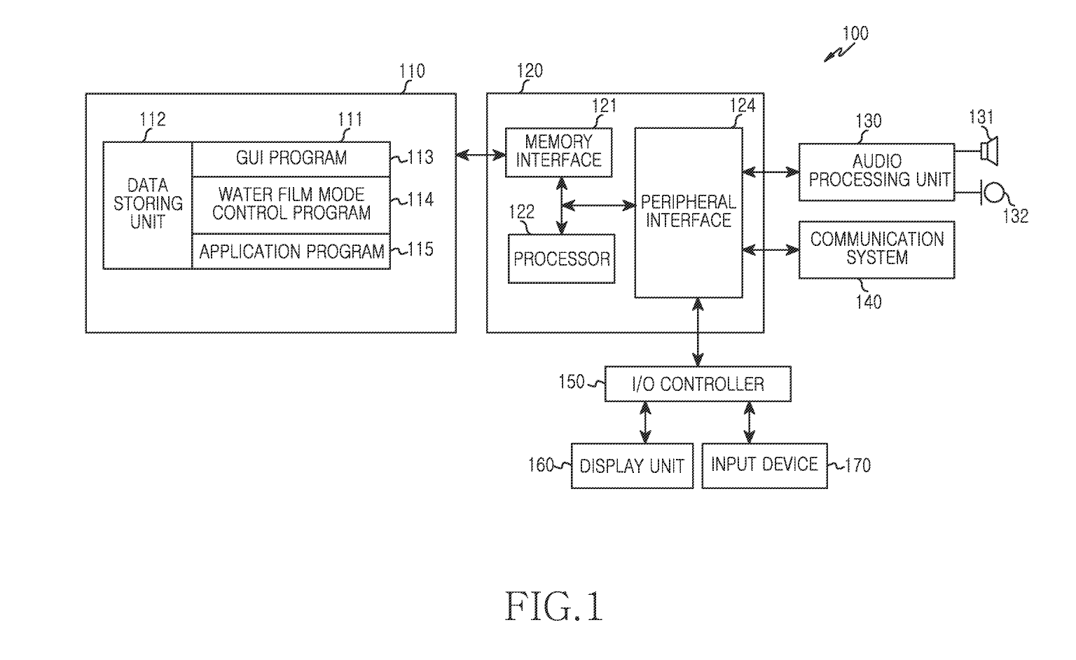

FIG. 1 is a block diagram illustrating a configuration of an electronic device according to an embodiment of the present disclosure.

Referring to FIG. 1, an electronic device 100 may include a memory 110, a processor unit 120, an audio processing unit 130, a communication system 140, an Input/Output (I/O) controller 150, a display unit 160, and an input device 170. Herein, the memory 110 may be a plurality of memories.

A description will be given for respective components as follows.

The memory 110 may include a program storing unit 111 for storing programs for controlling operations of the electronic device 100 and a data storing unit 112 for storing data generated while the programs are executed.

The program storing unit 111 may include a Graphic User Interface (GUI) program 113, a water film mode control program 114, and at least one application program 115. Herein, the programs included in the program storing unit 111 may be expressed in an instruction set as a set of instructions.

The data storing unit 112 may include at least one software component for storing at least one of position information, weather information, terrain information, building information, and a reference humidity, any of which may be used for controlling touch sensitivity.

The water film mode control program 114 may include at least one software component for estimating whether a water film is generated on a surface of a touch screen. In one example, the water film control program 114 detects a current position of the electronic device 100. When the current position of the electronic device 100 is in an area where it is raining, it recognizes that a water film will be generated on the surface of the touch screen. In another example, when humidity is detected, the water film mode control program 114 compares the detected humidity with a reference humidity. When the detected humidity is greater than or equal to the reference humidity, the water film mode control program 114 may recognize that a water film will be generated on the surface of the touch screen. In another example, when a temperature change is detected, the water film mode control program 114 compares temperatures measured in a first time point and a second time point. When the temperature measured in the second time point is higher than the temperature measured in the first time point, the water film mode control program 114 may recognize that a water film will be generated on the surface of the touch screen.

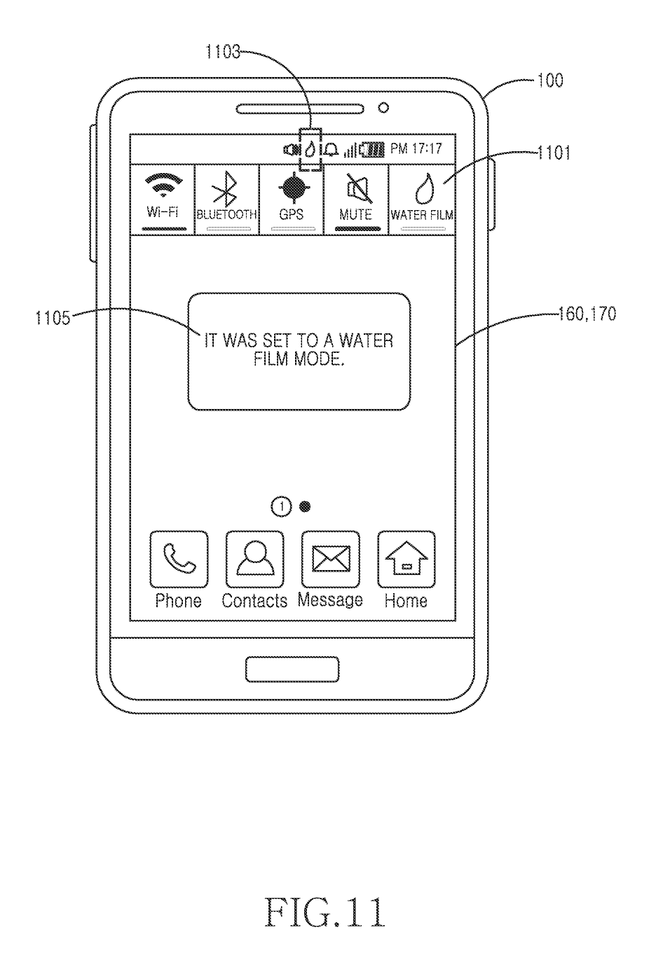

The water film mode control program 114 may include at least one software component for reducing touch detection sensitivity of the touch screen. In one example, the water film mode control program 114 reduces sensitivity of a touch panel to detect strong capacitance through the touch screen and not to detect weak capacitance. Herein, the water film mode control program 114 performs, as shown in FIG. 11, a control operation to display at least one of a water film mode icon 1103 and a water film mode notification 1105 through the GUI program 113.

The GUI program 113 may include at least one software component for providing a UI as graphics on the display unit 160. For example, the GUI program 113 performs, as shown in FIG. 11, a control operation to display at least one of the water film mode icon 1103 and the water film mode notification 1105 on the display unit 160 according to control of the water film mode control program 114.

The application program 115 may include a software component for at least one application program installed in the electronic device 100.

The processor unit 120 may include a memory interface 121, at least one processor 122, and a peripheral interface 124. Herein, the memory interface 121, at least the one processor 122, and the peripheral interface 124 which are included in the processor unit 120 may be integrated in at least one Integrated Circuit (IC) or be separately implemented.

The memory interface 121 controls that a component like the processor 122 or the peripheral interface 124 accesses the memory 110.

The peripheral interface 124 controls connection among an I/O peripheral of the electronic device 100, the processor 122, and the memory interface 121.

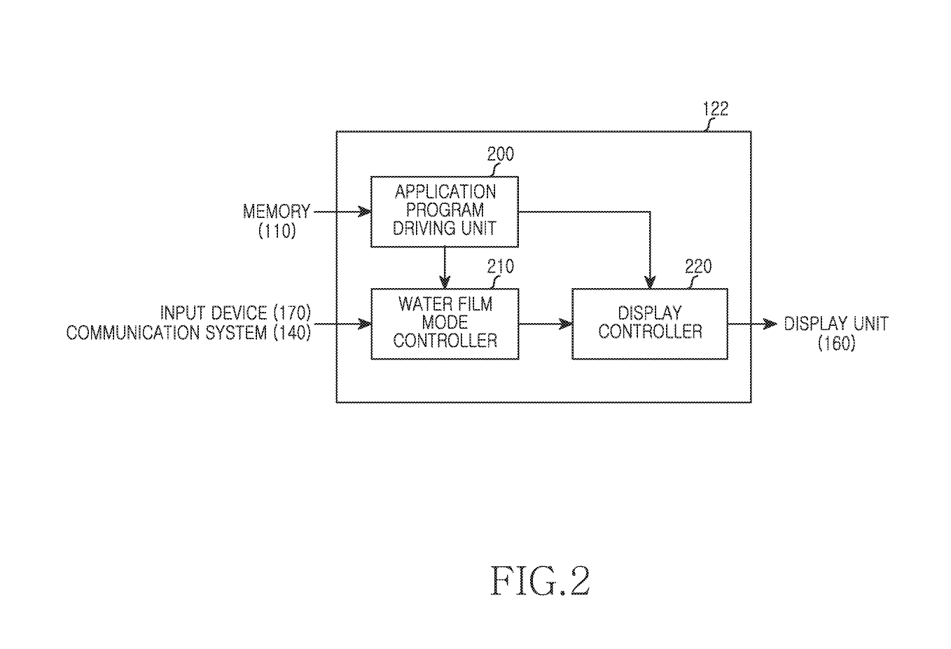

The processor 122 provides a variety of multimedia services using at least one software program. In addition, the processor 122 executes at least one program stored in the memory 110 and provides a service according to the corresponding program. For example, the processor 122 may be, as shown in FIG. 2, configured to execute the water film mode control program 114 and control touch sensitivity.

The audio processing unit 130 provides an audio interface between a user and the electronic device 100 through a speaker 131 and a microphone 132.

The communication system 140 may include at least one software component for performing a communication function for voice and data communication. Herein, the communication system 140 may be classified into a plurality of communication sub-modules which support different communication networks. For example, the communication network may be, but is not limited to, any one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, a Near Field Communication (NFC) network.

In addition, the communication system 140 may include a Global Positioning System (GPS) receiving unit for converting a signal received from an artificial satellite into information, such as position information, speed information, and time information. Herein, a distance between the satellite and the GPS receiving unit is calculated by multiplying the velocity of light by a signal arrival time. A position of the GPS receiving unit is measured by a triangulation method by obtaining accurate positions and distances of 3 satellites.

The I/O controller 150 provides an interface between I/O devices, such as the display device 160 and the input device 170, and the peripheral interface 124.

The display unit 160 displays state information of the electronic device 100, characters input by the user, moving pictures, still pictures, and the like. For example, the display unit 160 displays, as shown in FIG. 11, at least one of the water film mode icon 1103 and the water film mode notification 1105 by the GUI program 113. Herein, the display unit 160 may include a touch screen as an I/O device for performing outputting and inputting information. The touch screen provides touch information detected through a touch input unit to the processor unit 120 through the I/O controller 150. Herein, the touch input unit may provide touch information by an electronic pen or a finger of the user to the processor unit 120 through the I/O controller 150.

The input device 170 provides input data generated by selection of the user to the processor unit 120 through the I/O controller 150. In one example, the input device 170 includes a control button for control of the electronic device 100. In another example, the input device 170 may be configured as a keypad for receiving input data from the user.

FIG. 2 is a block diagram illustrating a configuration of a processor according to an embodiment of the present disclosure.

Referring to FIGS. 1 and 2, the processor 122 may include an application program driving unit 200, a water film mode controller 210, and a display controller 220.

The water film mode controller 210 executes the water film mode control program 113 of the program storing unit 111 and estimates whether a water film is generated on a surface of a touch screen. In one example, the water film mode controller 210 detects a current position of the electronic device 100. When the current position of the electronic device 100 is in an area where it is raining, it recognizes that a water film will be generated on the surface of the touch screen. In another example, when humidity is detected, the water film mode controller 210 compares the detected humidity with a reference humidity. When the detected humidity is greater than or equal to the reference humidity, the water film mode controller 210 may recognize that a water film will be generated on the surface of the touch screen. In another example, when a temperature change is detected, the water film mode controller 210 compares temperatures measured in a first time point and a second time point. When the temperature measured in the second time point is higher than the temperature measured in the first time point, the water film mode controller 210 may recognize that a water film will be generated on the surface of the touch screen.

The water film mode controller 210 executes the water film mode control program 113 and reduces touch detection sensitivity of the touch screen. In one example, the water film mode controller 210 reduces sensitivity of a touch panel to detect strong capacitance through the touch screen and not to detect weak capacitance. Herein, the water film mode controller 210 performs, as shown in FIG. 11, a control operation to display at least one of a water film mode icon 1103 and a water film mode notification 1105 through the display controller 220.

The display controller 220 executes the GUI program 113 of the program storing unit 111 and provides a UI as graphics on the display unit 160. For example, the display controller 220 performs, as shown in FIG. 11, a control operation to display at least one of the water film mode icon 1103 and the water film mode notification 1105 on the display unit 160 according to control of the water film mode controller 210.

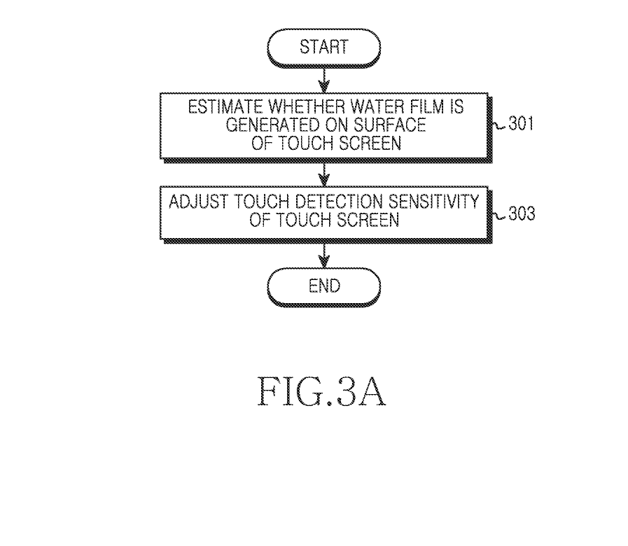

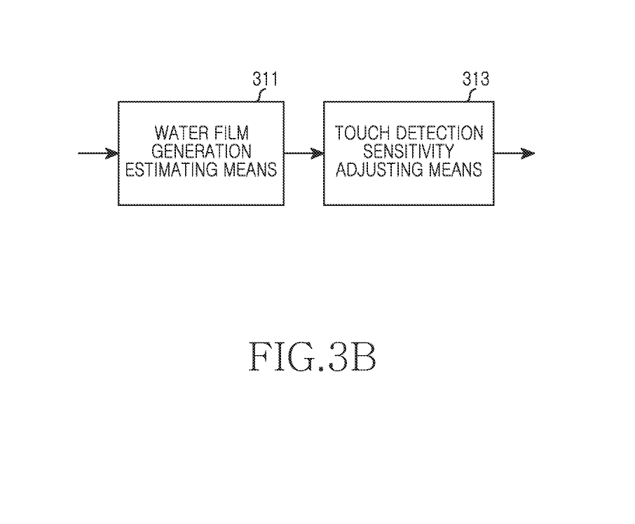

FIG. 3A is a flowchart illustrating a process of estimating whether a water film is generated on a surface of a touch screen and adjusting touch detection sensitivity of the touch screen according to an embodiment of the present disclosure.

Referring to FIG. 3A, the electronic device estimates whether a water film is generated on a surface of the touch screen in consideration of at least one of position information, humidity, and a temperature change thereof in operation 301. In one example, the electronic device detects its current position. When the current position of the electronic device is in an area where it is raining, it recognizes that a water film will be generated on the surface of the touch screen. In another example, when humidity is detected, the electronic device compares the detected humidity with a reference humidity. When the detected humidity is greater than or equal to the reference humidity, the electronic device may recognize that a water film will be generated on the surface of the touch screen. In another example, when a temperature change is detected, the electronic device compares temperatures measured in a first time point and a second time point. When the temperature measured in the second time point is higher than the temperature measured in the first time point, the electronic device may recognize that a water film will be generated on the surface of the touch screen.

After estimating whether the water film is generated on the surface of the touch screen, the electronic device proceeds to operation 303 and adjusts touch detection sensitivity of the touch screen. In one example, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

Thereafter, the electronic device ends the algorithm of FIG. 3A.

As described above, the process of controlling touch sensitivity in the electronic device may be configured, as shown in FIG. 3B, as an apparatus for controlling touch sensitivity in the electronic device.

FIG. 3B is a block diagram illustrating a configuration of an electronic device for estimating whether a water film is generated on a surface of a touch screen and adjusting touch detection sensitivity of the touch screen according to an embodiment of the present disclosure.

Referring to FIG. 3B, the electronic device may include a water film generation estimating means, that is, a first means 311 for estimating whether a water film is generated on the surface of the touch screen and a touch detection sensitivity adjusting means, that is, a second means 313 for adjusting touch detection sensitivity of the touch screen.

The first means 311 estimates whether the water film is generated on the surface of the touch screen. In one example, the electronic device detects its current position. When the current position of the electronic device is in an area where it is raining, it recognizes that a water film will be generated on the surface of the touch screen. In another example, when humidity is detected, the electronic device compares the detected humidity with a reference humidity. When the detected humidity is greater than or equal to the reference humidity, the electronic device may recognize that a water film will be generated on the surface of the touch screen. In another example, when a temperature change is detected, the electronic device compares temperatures measured in a first time point and a second time point. When the temperature measured in the second time point is higher than the temperature measured in the first time point, the electronic device may recognize that a water film will be generated on the surface of the touch screen.

The second means 313 adjusts touch detection sensitivity of the touch screen. In one example, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

As described above, the electronic device may include a plurality of means for controlling touch sensitivity. Herein, the electronic device may include the plurality of means for controlling the touch sensitivity as one means.

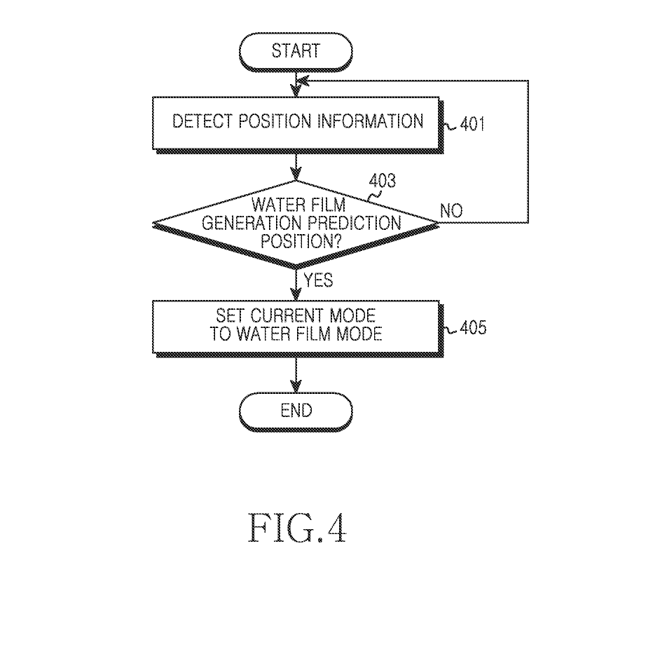

FIG. 4 is a flowchart illustrating a process of setting a water film mode in consideration of position information in an electronic device according to an embodiment of the present disclosure.

Referring to FIG. 4, the electronic device detects its position information in operation 401. In one example, the electronic device may estimate its current position using a satellite signal received from a GPS receiving unit of a communication system. In another example, the electronic device may estimate its current position using a triangulation method. In another example, the electronic device may estimate its current position using a wireless LAN service. Herein, it is assumed that the electronic device may recognize building information, weather information, terrain information, and the like, corresponding to its current position.

After detecting the position information, the electronic device proceeds to operation 403 and verifies whether the current position of the electronic device, which is detected in operation 401, is a water film generation prediction position. In one example, the electronic device verifies whether the current position of the electronic device, which is detected in operation 401, is a pool or in an area where it is raining. If the current position of the electronic device, which is detected in operation 401, is not a pool or an area where it is raining, the electronic device recognizes that a water film will be not generated on a surface of a touch screen. Accordingly, the electronic device proceeds to operation 401 and detects its position information.

On the other hand, when the current position is the water film generation prediction position, the electronic device proceeds to operation 405 and sets a current mode to a water film mode. For example, when the current position of the electronic device, which is detected in operation 401, is in an area where it is raining, the electronic device recognizes that a water film will be generated on the surface of the touch screen. Accordingly, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

The electronic device ends the algorithm of FIG. 4.

In an embodiment of the present disclosure, the electronic device sets a water film mode in consideration of its current position information.

In another embodiment of the present disclosure, the electronic device may set a water film mode in consideration of humidity.

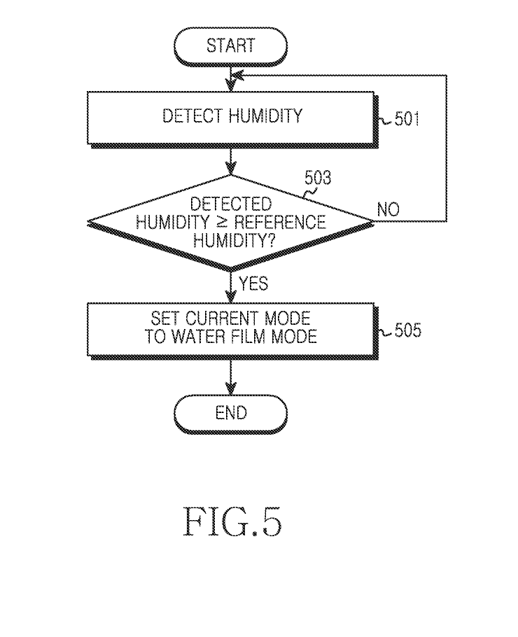

FIG. 5 is a flowchart illustrating a process of setting a water film mode in consideration of humidity in an electronic device according to an embodiment of the present disclosure.

Referring to FIG. 5, the electronic device detects humidity in operation 501. For example, the electronic device detects the humidity using a humidity sensor.

After detecting the humidity, the electronic device proceeds to operation 503 and compares the humidity detected in operation 501 with a reference humidity. Herein, the reference humidity may be preset by a designer of the electronic device when the electronic device is designed.

If the detected humidity is less than the reference humidity, the electronic device recognizes that a water film will be not generated on a surface of a touch screen. Accordingly, the electronic device proceeds to operation 501 and detects humidity.

On the other hand, when the detected humidity is greater than or equal to the reference humidity, the electronic device recognizes that a water film will be generated on the surface of the touch screen. Accordingly, the electronic device proceeds to operation 505 and sets a current mode to a water film mode. For example, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

The electronic device ends the algorithm of FIG. 5.

In an embodiment of the present disclosure, the electronic device sets a water film mode in consideration of humidity.

In another embodiment of the present disclosure, the electronic device may set a water film mode in consideration of a temperature which is sharply changed to a high temperature.

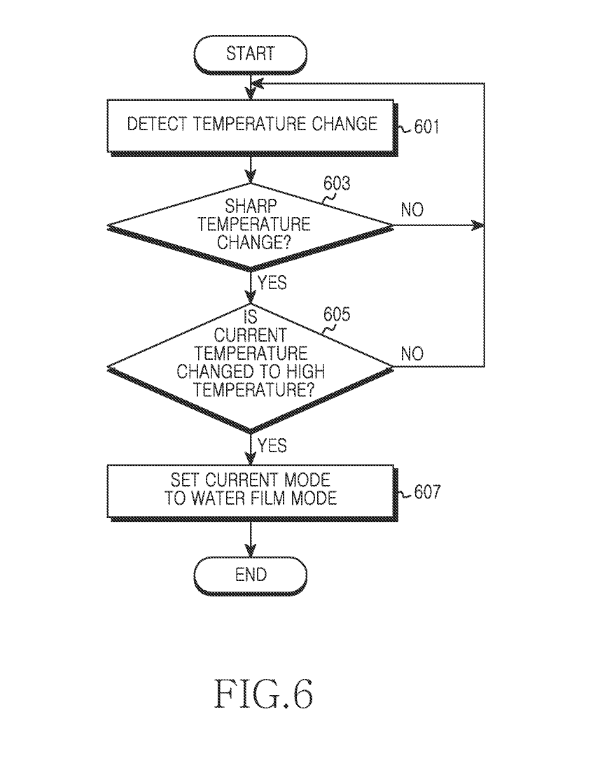

FIG. 6 is a flowchart illustrating a process of setting a water film mode in consideration of a temperature which is sharply changed to a high temperature in an electronic device according to an embodiment of the present disclosure.

Referring to FIG. 6, the electronic device detects a temperature change in operation 601. For example, when a temperature is periodically measured, the electronic device verifies whether a temperature measured in a first time point and a temperature measured in a second time point differ from each other. It is assumed that the first time point is older than the second time point.

After detecting the temperature change, the electronic device proceeds to operation 603 and verifies whether the detected temperature change is a sharp temperature change. Herein, the sharp temperature change means that a difference value between the temperature measured in the first time point and the temperature measured in the second time point is greater than or equal to a reference numerical value. If the detected temperature is not the sharp temperature change, the electronic device proceeds to operation 601 and detects a temperature change.

On the other hand, when the detected temperature change is the sharp temperature change, the electronic device proceeds to operation 605 and verifies whether a current temperature is changed to a high temperature. For example, the electronic device verifies whether the temperature measured in the second time point is higher than the temperature measured in the first time point. If the temperature measured in the second time point is not higher than the temperature measured in the first time point, the electronic device recognizes that the current temperature is not changed to the high temperature. Accordingly, the electronic device proceeds to operation 601 and detects a temperature change.

On the other hand, when the temperature measured in the second time point is higher than the temperature measured in the first time point, the electronic device recognizes that a water film will be generated on a surface of a touch screen. Accordingly, the electronic device proceeds to operation 607 and sets a current mode to a water film mode. For example, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

The electronic device ends the algorithm of FIG. 6.

In an embodiment of the present disclosure, the electronic device sets a water film mode according to a temperature which is sharply changed to a high temperature.

In another embodiment of the present disclosure, the electronic device may set a water film mode in consideration of a temperature which is sharply changed to a high temperature and humidity.

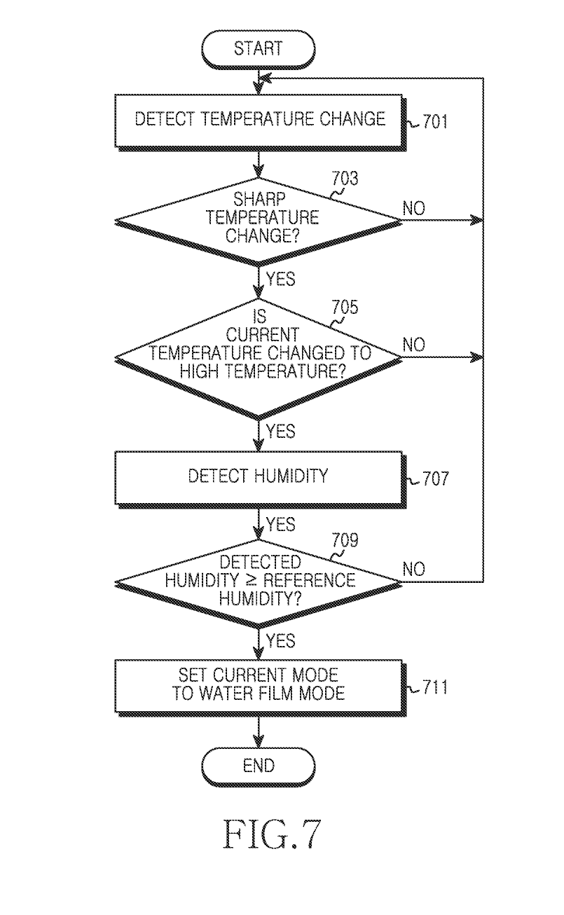

FIG. 7 is a flowchart illustrating a process of setting a water film mode in consideration of a temperature change and humidity in an electronic device according to an embodiment of the present disclosure.

Referring to FIG. 7, the electronic device detects a temperature change in operation 701. For example, when a temperature is periodically measured, the electronic device verifies whether a temperature measured in a first time point and a temperature measured in a second time point differ from each other. It is assumed that the first time point is older than the second time point.

After detecting the temperature change, the electronic device proceeds to operation 703 and verifies whether the detected temperature change is a sharp temperature change. Herein, the sharp temperature change means that a difference value between the temperature measured in the first time point and the temperature measured in the second time point is greater than or equal to a reference numerical value. If the detected temperature change is not the sharp temperature change, the electronic device proceeds to operation 701 and detects a temperature change.

On the other hand, when the detected temperature change is the sharp temperature change, the electronic device proceeds to operation 705 and verifies whether a current temperature is changed to a high temperature. For example, the electronic device verifies whether the temperature measured in the second time point is higher than the temperature measured in the first time point. If the temperature measured in the second time point is not higher than the temperature measured in the first time point, the electronic device recognizes that the current temperature is not changed to the high temperature. Accordingly, the electronic device proceeds to operation 701 and detects a temperature change.

On the other hand, when the temperature measured in the second time point is higher than the temperature measured in the first time point, the electronic device proceeds to operation 707 and detects humidity. For example, the electronic device detects the humidity using a humidity sensor.

After detecting the humidity, the electronic device proceeds to operation 709 and compares the humidity detected in operation 707 with a reference humidity. Herein, the reference humidity may be preset by a designer of the electronic device when the electronic device is designed.

If the detected humidity is less than the reference humidity, the electronic device recognizes that a water film will be not generated on a surface of a touch screen. Accordingly, the electronic device proceeds to operation 701 and detects a temperature change.

On the other hand, when the detected humidity is greater than or equal to the reference humidity, the electronic device recognizes that a water film will be generated on the surface of the touch screen. Accordingly, the electronic device proceeds to operation 711 and sets a current mode to a water film mode. For example, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

The electronic device ends the algorithm of FIG. 7.

In an embodiment of the present disclosure, the electronic device sets a water film mode in consideration of a temperature change and humidity.

In another embodiment of the present disclosure, the electronic device may set a water film mode in consideration of position information and humidity.

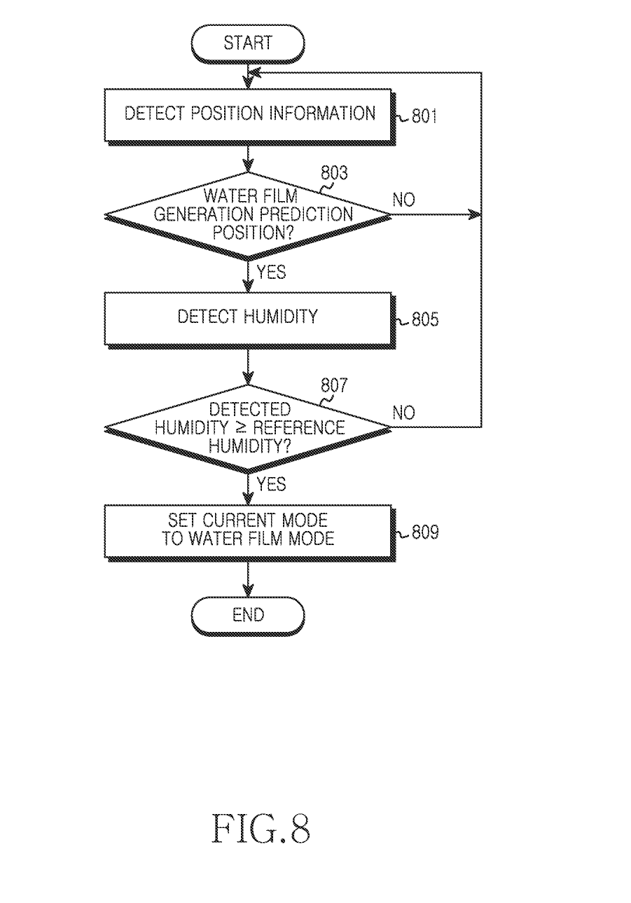

FIG. 8 is a flowchart illustrating a process of setting a water film mode in consideration of position information and humidity in an electronic device according to an embodiment of the present disclosure.

Referring to FIG. 8, the electronic device detects its position information in operation 801. In one example, the electronic device may estimate its current position using a satellite signal received from a GPS receiving unit of a communication system. In another example, the electronic device may estimate its current position using a triangulation method. In another example, the electronic device may estimate its current position using a wireless LAN service. Herein, it is assumed that the electronic device may recognize building information, weather information, terrain information, and the like corresponding to its current position.

After detecting the position information, the electronic device proceeds to operation 803 and verifies whether the current position of the electronic device, which is detected in operation 801, is a water film generation prediction position. For example, the electronic device verifies whether the current position of the electronic device, which is detected in operation 801, is a pool or in an area where it is raining. If the current position of the electronic device, which is detected in operation 801, is not a pool or an area where it is raining, the electronic device recognizes that a water film will be not generated on a surface of a touch screen. Accordingly, the electronic device proceeds to operation 801 and detects its position information.

On the other hand, when the current position is the water film generation prediction position, the electronic device proceeds to operation 805 and detects humidity. For example, the electronic device detects humidity using a humidity sensor.

After detecting humidity, the electronic device proceeds to operation 807 and compares the humidity detected in operation 805 with a reference humidity. Herein, the reference humidity may be preset by a designer of the electronic device when the electronic device is designed.

If the detected humidity is less than the reference humidity, the electronic device recognizes that a water film will be not generated on the surface of the touch screen. Accordingly, the electronic device proceeds to operation 801 and detects its position information.

On the other hand, when the detected humidity is greater than or equal to the reference humidity, the electronic device recognizes that a water film will be generated on the surface of the touch screen. Accordingly, the electronic device proceeds to operation 809 and sets a current mode to a water film mode. For example, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

The electronic device ends the algorithm of FIG. 8.

In an embodiment of the present disclosure, the electronic device sets a water film mode in consideration of a position and humidity.

In another embodiment of the present disclosure, the electronic device may set a water film mode in consideration of a position and a temperature.

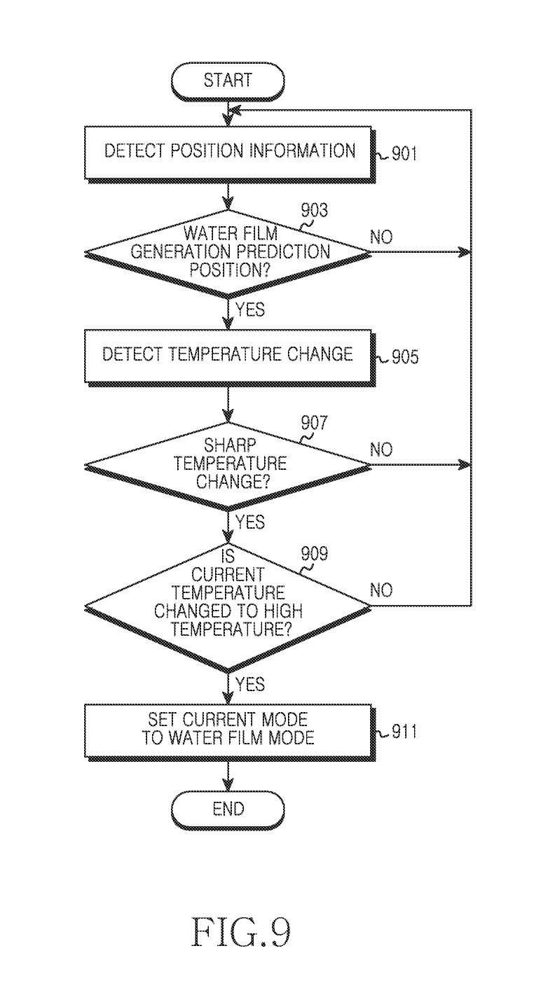

FIG. 9 is a flowchart illustrating a process of setting a water film mode in consideration of position information and a temperature change in an electronic device according to an embodiment of the present disclosure.

Referring to FIG. 9, the electronic device detects its position information in operation 901. In one example, the electronic device may estimate its current position using a satellite signal received from a GPS receiving unit of a communication system. In another example, the electronic device may estimate its current position using a triangulation method. In another example, the electronic device may estimate its current position using a wireless LAN service. Herein, it is assumed that the electronic device may recognize building information, weather information, terrain information, and the like corresponding to its current position.

After detecting the position information, the electronic device proceeds to operation 903 and verifies whether the current position of the electronic device, which is detected in operation 901, is a water film generation prediction position. In one example, the electronic device verifies whether the current position of the electronic device, which is detected in operation 901, is a pool or in an area where it is raining. If the current position of the electronic device, which is detected in operation 901, is not a pool or an area where it's raining, the electronic device recognizes that a water film will be not generated on a surface of a touch screen. Accordingly, the electronic device proceeds to operation 901 and detects its position information.

On the other hand, when the current position is the water film generation prediction position, the electronic device proceeds to operation 905 and detects a temperature change. For example, when a temperature is periodically measured, the electronic device verifies whether a temperature measured in a first time point and a temperature measured in a second time point differ from each other. It is assumed that the first time point is older than the second time point.

After detecting the temperature change, the electronic device proceeds to operation 907 and verifies whether the detected temperature change is a sharp temperature change. Herein, the sharp temperature change means that a difference value between the temperature measured in the first time point and the temperature measured in the second time point is greater than or equal to a reference numerical value. If the detected temperature is not the sharp temperature change, the electronic device proceeds to operation 901 and detects position information.

On the other hand, when the detected temperature change is the sharp temperature change, the electronic device proceeds to operation 909 and verifies whether a current temperature is changed to a high temperature. For example, the electronic device verifies whether a temperature measured in a second time point is higher than a temperature measured in a first time point. If the temperature measured in the second time point is not higher than the temperature measured in the first time point, the electronic device recognizes that the current temperature is not changed to the high temperature. Accordingly, the electronic device proceeds to operation 901 and detects position information.

On the other hand, when the temperature measured in the second time point is higher than the temperature measured in the first time point, the electronic device recognizes that a water film will be generated on a surface of a touch screen. Accordingly, the electronic device proceeds to operation 911 and sets a current mode to a water film mode. For example, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

The electronic device ends the algorithm of FIG. 9.

In an embodiment of the present disclosure, the electronic device sets a water film mode according to position information and a temperature.

In another embodiment of the present disclosure, the electronic device may set a water film mode in consideration of position information, a temperature, and humidity.

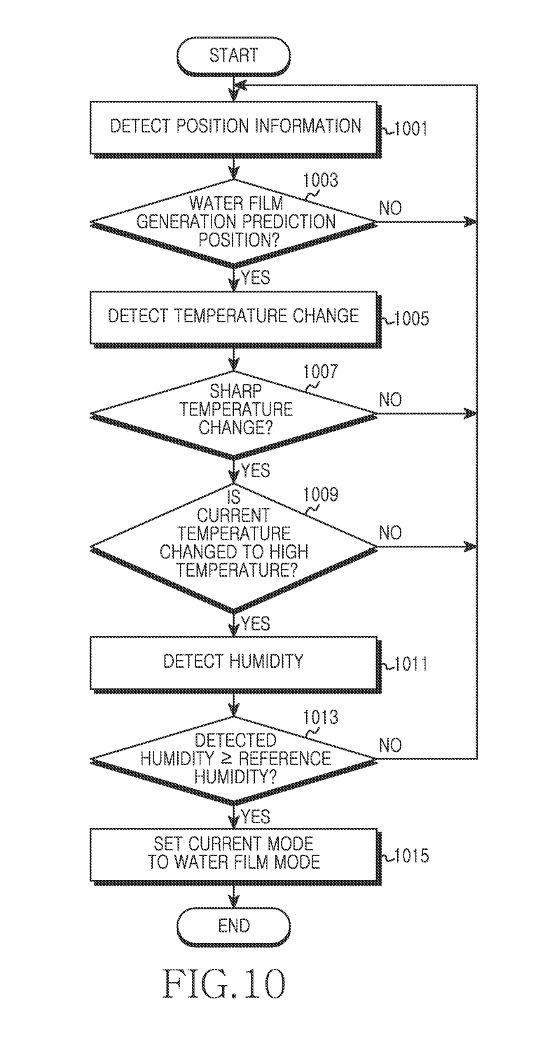

FIG. 10 is a flowchart illustrating a process of setting a water film mode in consideration of position information, a temperature, and humidity in an electronic device according to an embodiment of the present disclosure.

Referring to FIG. 10, the electronic device detects its position information in operation 1001. In one example, the electronic device may estimate its current position using a satellite signal received from a GPS receiving unit of a communication system. In another example, the electronic device may estimate its current position using a triangulation method. In another example, the electronic device may estimate its current position using a wireless LAN service. Herein, it is assumed that the electronic device may recognize building information, weather information, terrain information, and the like corresponding to its current position.

After detecting the position information, the electronic device proceeds to operation 1003 and verifies whether the current position of the electronic device, which is detected in operation 1001, is a water film generation prediction position. In one example, the electronic device verifies whether the current position of the electronic device, which is detected in operation 1001, is a pool or in an area where it is raining. If the current position of the electronic device, which is detected in operation 1001, is not a pool or an area where it is raining, the electronic device recognizes that a water film will be not generated on a surface of a touch screen. Accordingly, the electronic device proceeds to operation 1001 and detects its position information.

When the current position is the water film generation prediction position, the electronic device proceeds to operation 1005 and detects a temperature change. For example, when a temperature is periodically measured, the electronic device verifies whether a temperature measured in a first time point and a temperature measured in a second time point differ from each other. It is assumed that the first time point is older than the second time point.

After detecting the temperature change, the electronic device proceeds to operation 1007 and verifies whether the detected temperature change is a sharp temperature change. Herein, the sharp temperature change means that a difference value between the temperature measured in the first time point and the temperature measured in the second time point is greater than or equal to a reference numerical value. If the detected temperature is not the sharp temperature change, the electronic device proceeds to operation 1001 and detects its position information.

On the other hand, when the detected temperature change is the sharp temperature change, the electronic device proceeds to operation 1009 and verifies whether a current temperature is changed to a high temperature. For example, the electronic device verifies whether the temperature measured in the second time point is higher than the temperature measured in the first time point. If the temperature measured in the second time point is not higher than the temperature measured in the first time point, the electronic device recognizes that the current temperature is not changed to the high temperature. Accordingly, the electronic device proceeds to operation 1001 and detects its position information.

On the other hand, when the temperature measured in the second time point is higher than the temperature measured in the first time point, the electronic device proceeds to operation 1011 and detects humidity. For example, the electronic device detects humidity using a humidity sensor.

After detecting humidity, the electronic device proceeds to operation 1013 and compares the humidity detected in operation 1011 with a reference humidity. Herein, the reference humidity may be preset by a designer of the electronic device when the electronic device is designed.

If the detected humidity is less than the reference humidity, the electronic device recognizes that a water film will be not generated on a surface of a touch screen. Accordingly, the electronic device proceeds to operation 1001 and detects its position information.

On the other hand, when the detected humidity is greater than or equal to the reference humidity, the electronic device recognizes that a water film will be generated on the surface of the touch screen. Accordingly, the electronic device proceeds to operation 1015 and sets a current mode to a water film mode. For example, the electronic device reduces sensitivity of a touch panel to detect strong capacitance through the touch screen and not to detect weak capacitance. Herein, the electronic device may display, as shown in FIG. 11, at least one of a water film mode icon 1103 and a water film mode notification 1105 on a display unit.

The electronic device ends the algorithm of FIG. 10.

In an embodiment of the present disclosure, the electronic device sets a water film mode in consideration of at least one of position information, humidity, and a temperature change.

In another embodiment of the present disclosure, if necessary, the electronic device may set a water film mode through an icon 1101 for setting the water film mode.

In another embodiment of the present disclosure, if necessary, the electronic device may release setting of a water film mode through the icon 1101 for setting the water film mode.

As described above, the electronic device may prevent an operating error due to a water film by reducing sensitivity of a touch and detecting a touch for strong capacitance when the water film is generated on the touch screen.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling touch sensitivity in an electronic device, the method comprising:
estimating whether a water film is generated on a surface of a touch screen in consideration of at least one of position information, humidity, and a temperature change of the electronic device; and
adjusting touch detection sensitivity of the touch screen when it is estimated that the water film is generated on the surface of the touch screen.

2. The method of claim 1, wherein the estimating of whether the water film is generated on the surface of the touch screen comprises:
detecting position information of the electronic device; and
estimating that the water film is generated on the surface of the touch screen when the position information indicates a water film generation prediction position.

3. The method of claim 1, wherein the estimating of whether the water film is generated on the surface of the touch screen comprises:
detecting humidity;
verifying whether the detected humidity is higher than a reference humidity; and
estimating that the water film is generated on the surface of the touch screen when the detected humidity is greater than the reference humidity.

4. The method of claim 1, wherein the estimating of whether the water film is generated on the surface of the touch screen comprises:
detecting a temperature change in consideration of temperatures measured in a first time point and a second time point;
verifying whether the temperature change is equal to or greater than a reference temperature change;
verifying whether the temperature measured in the second time point is higher than the temperature measured in the first time point when the temperature change is equal to or greater than the reference temperature change; and
estimating that the water film is generated on the surface of the touch screen when the temperature measured in the second time point is higher than the temperature measured in the first time point.

5. The method of claim 1, wherein the estimating of whether the water film is generated on the surface of the touch screen comprises:
detecting position information of the electronic device;
detecting humidity when the position information indicates a water film generation prediction position;
verifying whether the detected humidity is higher than a reference humidity; and
estimating that the water film is generated on the surface of the touch screen when the detected humidity is higher than the reference humidity.

6. The method of claim 1, wherein the estimating of whether the water film is generated on the surface of the touch screen comprises:
detecting position information of the electronic device;
detecting a temperature change in consideration of temperatures measured in a first time point and a second time point when the position information indicates a water film generation prediction position;
verifying whether the temperature change is equal to or greater than a reference temperature change;
verifying whether the temperature measured in the second time point is higher than the temperature measured in the first time point when the temperature change is equal to or greater than the reference temperature change; and
estimating that the water film is generated on the surface of the touch screen when the temperature measured in the second time point is higher than the temperature measured in the first time point.

7. The method of claim 1, wherein the estimating of whether the water film is generated on the surface of the touch screen comprises:
detecting a temperature change in consideration of temperatures measured in a first time point and a second time point;
verifying whether the temperature change is equal to or greater than a reference temperature change;
verifying whether the temperature measured in the second time point is higher than the temperature measured in the first time point when the temperature change is equal to or greater than the reference temperature change;
detecting humidity when the temperature measured in the second time point is higher than the temperature measured in the first time point;
verifying whether the detected humidity is higher than a reference humidity; and
estimating that the water film is generated on the surface of the touch screen when the detected humidity is higher than the reference humidity.

8. The method of claim 1, wherein the estimating of whether the water film is generated on the surface of the touch screen comprises:
detecting position information of the electronic device;
detecting a temperature change in consideration of temperatures measured in a first time point and a second time point when the position information indicates a water film generation prediction position;
verifying whether the temperature change is equal to or greater than a reference temperature change;
verifying whether the temperature measured in the second time point is higher than the temperature measured in the first time point when the temperature change is equal to or greater than the reference temperature change;
detecting humidity when the temperature measured in the second time point is higher than the temperature measured in the first time point;
verifying whether the detected humidity is higher than a reference humidity; and
estimating that the water film is generated on the surface of the touch screen when the detected humidity is higher than the reference humidity.

9. The method of claim 1, wherein the adjusting of the touch detection sensitivity of the touch screen comprises reducing the touch detection sensitivity of the touch screen to detect strong capacitance through the touch screen and not to detect weak capacitance.

10. An electronic device comprising:
a touch screen;
at least one processor;
at least one memory; and
at least one program which is stored in the at least the one memory and is configured to be executable by the at least the one processor,
wherein the at least the one processor estimates whether a water film is generated on a surface of a touch screen in consideration of at least one of position information, humidity, and a temperature change of the electronic device and adjusts touch detection sensitivity of the touch screen when it is estimated that the water film is generated on the surface of the touch screen.

11. The electronic device of claim 10, wherein the at least the one processor detects position information of the electronic device and estimates that the water film is generated on the surface of the touch screen when the position information indicates a water film generation prediction position.

12. The electronic device of claim 10, wherein the at least the one processor detects humidity, verifies whether the detected humidity is higher than a reference humidity, and estimates that the water film is generated on the surface of the touch screen when the detected humidity is greater than the reference humidity.

13. The electronic device of claim 10, wherein the at least the one processor detects a temperature change in consideration of temperatures measured in a first time point and a second time point, verifies whether the temperature change is equal to or greater than a reference temperature change, verifies whether the temperature measured in the second time point is higher than the temperature measured in the first time point when the temperature change is equal to or greater than the reference temperature change, and estimates that the water film is generated on the surface of the touch screen when the temperature measured in the second time point is higher than the temperature measured in the first time point.

14. The electronic device of claim 10, wherein the at least the one processor detects position information of the electronic device, detects humidity when the position information indicates a water film generation prediction position, verifies whether the detected humidity is higher than a reference humidity, and estimates that the water film is generated on the surface of the touch screen when the detected humidity is higher than the reference humidity.

15. The electronic device of claim 10, wherein the at least the one processor detects position information of the electronic device, detects a temperature change in consideration of temperatures measured in a first time point and a second time point when the position information indicates a water film generation prediction position, verifies whether the temperature change is equal to or greater than a reference temperature change, verifies whether the temperature measured in the second time point is higher than the temperature measured in the first time point when the temperature change is equal to or greater than the reference temperature change, and estimates that the water film is generated on the surface of the touch screen when the temperature measured in the second time point is higher than the temperature measured in the first time point.

16. The electronic device of claim 10, wherein the at least the one processor detects a temperature change in consideration of temperatures measured in a first time point and a second time point, verifies whether the temperature change is equal to or greater than a reference temperature change, verifies whether the temperature measured in the second time point is higher than the temperature measured in the first time point when the temperature change is equal to or greater than the reference temperature change, detects humidity when the temperature measured in the second time point is higher than the temperature measured in the first time point, verifies whether the detected humidity is higher than a reference humidity, and estimates that the water film is generated on the surface of the touch screen when the detected humidity is higher than the reference humidity.

17. The electronic device of claim 10, wherein the at least the one processor detects position information of the electronic device, detects a temperature change in consideration of temperatures measured in a first time point and a second time point when the position information indicates a water film generation prediction position, verifies whether the temperature change is equal to or greater than a reference temperature change, verifies whether the temperature measured in the second time point is higher than the temperature measured in the first time point when the temperature change is equal to or greater than the reference temperature change, detects humidity when the temperature measured in the second time point is higher than the temperature measured in the first time point, verifies whether the detected humidity is higher than a reference humidity, and estimates that the water film is generated on the surface of the touch screen when the detected humidity is higher than the reference humidity.

18. The electronic device of claim 10, wherein the at least the one processor reduces the touch detection sensitivity of the touch screen to detect strong capacitance through the touch screen and not to detect weak capacitance.
